(19) United States
(12) Patent Application Publication
(10) Pub. No.: US 2006/0023811 A1
(43) Pub. Date: Feb. 2, 2006

(54) Digital I/Q demodulator suitable for use in wireless networks and an associated method of demodulating an RF signal

(76) Inventor: Weon-Ki Yoon, Plano, TX (US)

Correspondence Address: Steven J. Laureanti;Samsung Telecommunications America, L.P., 1301 East Lookout Drive, Richardson, TX, 75082, US

(21) Appl. No.: 10/901,886

(22) Filed: Jul. 29, 2004

(51) Int. Cl. H04L 27/14

(52) U.S. Cl. 375/326

(57) ABSTRACT

A digital in-phase/quadrature (I/Q) demodulator for use in RF receivers, wireless base stations, wireless mobile stations and other components of wireless networks. The digital I/Q demodulator extracts and resolves I and Q components of a demodulated digital data signal from a modulated digital data signal input thereto. The digital I/Q demodulator includes a self contained carrier signal recovery loop for constructing, from acquired phase information and a frequency input the digital I/Q demodulator from a first of plural programmable inputs thereto, a local carrier signal used in the demodulation process.

### FIELD OF THE INVENTION

This invention generally relates to wireless networks and, more specifically, to a digital I/Q demodulator suitable for use in both wireless base stations and wireless mobile stations.

### BACKGROUND OF THE INVENTION

A typical wireless transceiver includes, at a minimum, two key elements—a radio frequency (RF) transmitter, and an RF receiver. In turn, the RF receiver can be subdivided into plural subsystems, one of which is the demodulator. When a modulated RF signal is intercepted by an RF receiver, the intercepted RF signal undergoes a demodulation process. Broadly speaking, the demodulation process extracts a data signal from the intercepted RF signal. If the demodulator also resolves the amplitude and phase information of the intercepted RF signal into its in-phase and quadrature (I/Q) components during the demodulation process, the demodulator is referred to as an I/Q demodulator.

In order to demodulate the intercepted RF signal, a demodulator requires a local carrier signal having a frequency which matches the frequency of an oscillator within the RF transmitter that generated the RF signal intercepted by the RF receiver. If the frequency of the local carrier signal is not closely matched to the frequency of the transmitter oscillator, the RF receiver cannot efficiently demodulate the received signal. While the RF receiver may be constructed to include a local oscillator designed to generate a local carrier signal having a frequency close to that of the transmitter oscillator, variations in manufacturing and differences in operating environments will periodically cause an offset between the frequency of the local carrier signal generated by the receiver oscillator and that of the transmitter oscillator. To compensate for periodic offsets between the frequency of the local carrier signal and the frequency of the carrier signal generated by the transmitter oscillator, the local carrier signal of the receiver oscillator is typically locked to the carrier signal of the transmitter oscillator using a carrier recovery loop that ties the frequency of the receiver oscillator to the frequency of the transmitter oscillator.

While the precise definition of a carrier signal recovery loop for an RF receiver tends to vary, typically, the carrier signal recovery loop is considered to include, at a minimum, those components used to generate a local carrier signal having a frequency which matches the frequency of the transmitter oscillator. Oftentimes, the carrier signal recovery loop may also include the electrical connections used to inject the generated local carrier signal into one or more circuits and/or devices which use the local carrier signal to demodulate or otherwise process the intercepted RF signal. Finally, the carrier signal recovery loop may include those electrical connections which feed the components used to generate the local carrier signal with the output of the demodulator itself.

Prior carrier signal recovery loops incorporated into RF receivers have been characterized by a number of deficiencies. Oftentimes, carrier signal recovery loops were constructed using plural devices, the predominate portion of which were analog devices. As analog devices have non-linear characteristics, carrier signal recovery loops incorporating analog devices tend to give less accurate responses. RF receivers were also configured to include convoluted and/or multiple carrier signal recovery loops. For example, an RF receiver configured to include carrier signal recovery loops for each of the RF down converter, analog I/Q demodulator and analog-to-digital (A/D) converters, all of which are routed through selected components of the baseband processing circuit thereof is known. When an RF receiver such as the RF receiver hereinabove described is constructed of analog components or configured to include convoluted or multiple carrier signal recovery loops, the overall loop response for the RF receiver becomes complicated and the response time, long.

As noted above, there are numerous deficiencies associated with current techniques for using a carrier signal recovery loop to generate a local carrier signal for subsequent use in demodulating or otherwise processing an RF signal. Accordingly, what is needed is a simplified carrier signal recovery loop composed entirely of digital components and suitable for containment within the circuit, device or sub-system requiring the local carrier signal. By doing so, the circuit, device or sub-system, for example, a demodulator, as well as systems incorporating the circuit, device or sub-system, for example, RF receivers, RF transceivers, wireless mobile stations and wireless base stations, would enjoy both enhanced operating characteristics and reduced manufacturing costs.

### SUMMARY OF THE INVENTION

In one embodiment, the present invention is directed to a digital I/Q demodulator comprised of a first demodulation sub-circuit, a second demodulation sub-circuit, a carrier signal phase offset detection sub-circuit and a carrier signal generation sub-circuit. Using first and second carrier signals generated by the carrier signal generation sub-circuit, the first and second demodulation sub-circuits demodulate and resolve a portion of a received modulated digital signal, thereby generating I and Q components, respectively, of a demodulated digital data signal By passively monitoring the I and Q components of the demodulated digital data signal respectively generated by the first and second demodulation sub-circuits, the carrier signal phase offset detection sub-circuit acquires phase information for subsequent use in determining a phase offset. In turn, the determined phase offset is routed to the carrier signal generation sub-circuit for construction of the first and second carrier signals. The first and second carrier signals are subsequently returned to the first and second demodulation sub-circuits, respectively, for use in demodulating subsequent portions of the modulated digital signal. Uniquely, the digital I/Q demodulator includes a carrier signal recovery loop contained, in its entirety, within the digital I/Q demodulator.

In further aspects thereof, the digital I/Q demodulator may include any number of programmable inputs for use in: (1) providing the carrier signal generation sub-circuit with a selected frequency for the generated carrier signal; (2) adjusting the phase offset determined by the carrier signal phase offset detector sub-circuit; or (3) setting a range for the phase offset. The digital I/Q demodulator may also be provided with a clock input with which a frequency range for the carrier signal to be generated by the carrier signal generation sub-circuit may be set.

In another embodiment, the present invention is directed to an RF receiver comprised of an A/D converter for converting a modulated analog RF signal into a modulated digital RF signal and a digital I/Q demodulator for producing I and Q components of a demodulated digital RF signal from the modulated digital RF signal. The digital I/Q demodulator includes a self-contained digital carrier signal recovery loop for generating a phase offset corrected carrier signal for use in producing, from the modulated digital RF signal produced by the A/D converter, the I and Q components of the demodulated digital RF signal. In various aspects thereof, the digital IQ demodulator may include a clock input from which a frequency range for the phase offset corrected carrier signal is determined, a first programmable input for providing the digital I/Q demodulator with a selected frequency for the phase offset corrected carrier signal, second and third programmable inputs for setting a phase offset range for the phase offset corrected carrier signal or a fourth programmable input for adjusting phase offset for the phase offset corrected carrier signal.

### BRIEF DESCRIPTION OF THE DRAWINGS

For a more complete understanding of the present invention, reference is now made to the following detailed description, taken in conjunction with the accompanying drawings, in which:

FIG. 1 is a block diagram of a wireless network constructed in accordance with the teachings of the present invention;

FIG. 2 is a block diagram of a base station of the wireless network of FIG. 1;

FIG. 3 is a block diagram of an RF receiver which forms part of an RF transceiver of the base station of FIG. 2;

FIG. 4 is a block diagram of a digital I/Q demodulator of the RF receiver of FIG. 3;

FIG. 5 is a flow chart of a method for demodulating an analog modulated RF signal; and

FIG. 6 is a block diagram of an RF receiver which incorporates plural digital I/Q demodulators.

### NOTATION AND NOMENCLATURE

Certain terms are used throughout the detailed description and claims that follows to refer to particular system components. As one skilled in the art will appreciate, different names may be used to refer to the same components. Accordingly, this document does not intend to distinguish between components that differ in name, but not in function.

Also, in the detailed description and claims which follow, the terms “including” and “comprising” are used in an open-ended fashion, and thus should be interpreted to mean “including, but not limited to . . . ”.

The term “couple” or “couples” is intended to mean either an indirect or direct electrical, mechanical, thermal or communicative connection. The term “couple” or “couples” is further intended to encompass both wireline connections and wireless connections. Thus, if a first device is coupled to a second device, that connection may be through a direct wireline connection, a direct wireless connection, an indirect wireline connection via other devices and/or connections, an indirect wireless connection via other devices and/or connections or a connection which itself is a combination of the aforementioned wireline and wireless connections.

The term “or” is used in an inclusive fashion and should be interpreted to mean “and/or.”

The terms “associated with” and “associated therewith”, as well as derivatives thereof, may mean “to include”, “be included within”, “interconnect with”, “contain”, “be contained within”, “connect to”, “connect with”, “couple to”, “couple with”, “be communicable with”, “cooperate with”, “interleave”, “juxtapose”, “be proximate to”, “be bound to”, “be bound with”, “have”, “have a property of”, or the like.

The term “controller” means any device, system or part thereof that controls at least one operation and is implemented hardware, firmware, software, or a combination thereof. Functionality associated with any particular controller may be centralized or distributed, whether locally or remotely.

Definitions for certain other words and phrases may be provided throughout this patent document. Those of ordinary skill in the art should understand that in many, if not most instances, such definitions apply to prior, as well as future uses of such defined words and phrases.

### DETAILED DESCRIPTION

In the disclosure which follows, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Furthermore, the foregoing description omits various details which are believed to not be necessary to obtain a complete understanding of the present invention or are considered to be within the understanding of persons of ordinary skill in the relevant art.

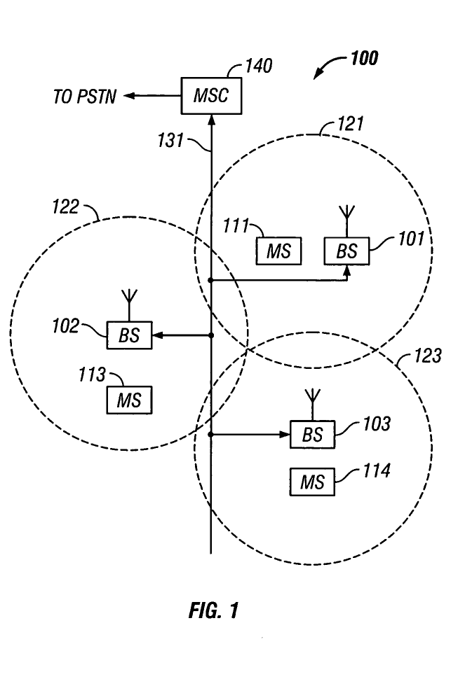

Referring first to FIG. 1, a wireless network 100 constructed in accordance with the teachings of the present invention will now be described in greater detail. As may now be seen, the wireless network 100 comprises a plurality of cell sites 121, 122 and 123, each of which respectively contains a corresponding one of a plurality of base stations (BSs) 101, 102 and 103. In turn, each one of the base stations 101, 102 and 103 are operable to communicate with a plurality of mobile stations (MSs) 111, 113 and 114. It is contemplated that each one of the mobile stations 111, 113, 114 may be any one of a wide variety of wireless devices, for example, wireless telephones, pagers, personal digital assistants (PDAS) or portable computers, configured for operations within the wireless network 100. In FIG. 1, dotted lines show the approximate boundaries of the cell sites 121, 122 and 123 in which the BSs 101, 102 and 103 are respectively located. The cell sites 121, 122 and 123 are shown as having a generally circular shape for purposes of illustration and explanation only. It should be clearly understood that the cell sites may have other, irregular, shapes, depending on the cell configuration selected and natural and man-made obstructions. Furthermore, FIG. 1 shows the wireless network 100 as having three cell sites 121, 122 and 123 and three MSs 111, 113 and 114, each one of the MSs 111, 113 and 114 operating within one of the cell sites 121, 122 and 123. It should be clearly understood that the foregoing configuration is disclosed purely by way of example and it is fully contemplated that the wireless network 100 may be comprised of any number of cell sites in each of which various numbers of MSs may operate.

BS 101, BS 102 and BS 103 transfer voice and data signals between each other and the public switched telephone network (PSTN) (not shown) via communications line 131 and mobile switching center (MSC) 140. As is well known in the art, the MSC 140 is a switching device that provides services to subscribers to a wireless network and coordination between the subscribers to the wireless network and external networks, for example, the PSTN. Communications line 131 may be any suitable connection means, for example, a T1 line, a T3 line, a fiber optic link or a network backbone connection. In some embodiments of the present invention, the communications line may be several different data links, for example, where each data link couples one of the BSs 101, 102 and 103 to the MSC 140. In the example of the wireless network 100 shown in FIG. 1, the MS 111 is located in the cell site 121 and is in communication with the BS 101. Similarly, the MS 113 is located in the cell site 122 and is in communication with the BS 102 and the MS 114 is located in the cell site 123 and is in communication with the BS 103.

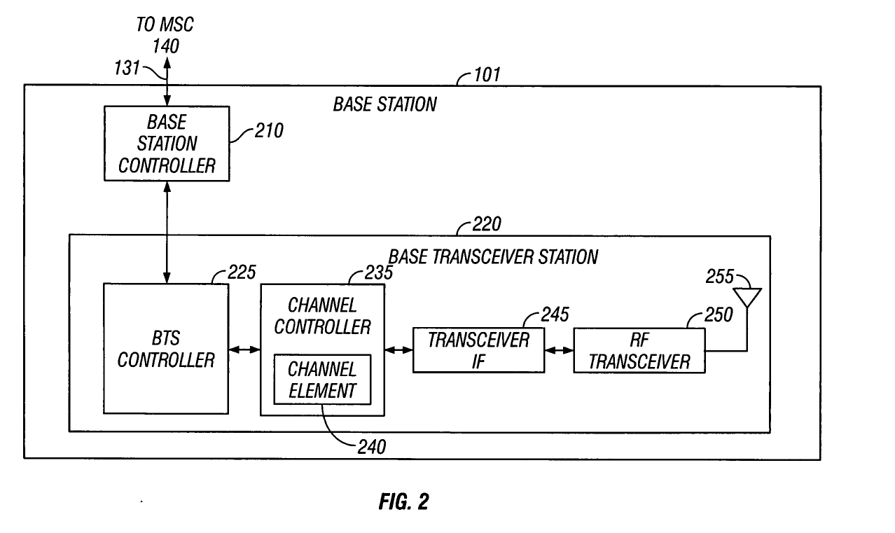

Referring next to FIG. 2, the base station 101 will now be described in greater detail. As the remaining base stations 102 and 103 of the wireless network 100 are similarly configured to the base station 101, the description of the base station 101 which follows applies equally to the base stations 102 and 103. As may now be seen, the base station 101 is comprised of a base station controller (BSC) 210 and base transceiver station (BTS) 220. The BSC 210 manages wireless communications resources, including the BTS 220, for a specified cell or cells, here, the cell site 121, within the wireless network 100. Conversely, the BTS 220 comprises a BTS controller 225, a channel controller 235, which contains one or more representative channel elements 240, a transceiver interface (IF) 245, an RF transceiver 250 and an antenna array 255. Additionally, the BTS 220 typically includes other electrical equipment not shown in FIG. 2, for example, air conditioning units, heating units, telephone line interfaces and the like.

The BTS controller 225 comprises processing circuitry and memory capable of executing an operating program that controls the overall operation of the BTS 220 and communicates with the BSC 210. Under normal conditions, the BTS controller 225 directs the operation of the channel controller 235, which, in turn, contains a number of channel elements, including the channel element 240, that perform bi-directional communications in both the forward channel and the reverse channel. Generally, the forward channel refers to outbound signals transferred, from the channel element 240 of the base station 101, to a mobile station in the coverage area of the base station 101 via the transceiver IF 245, the RF transceiver 250 and the antenna array 255 while the reverse channel refers to inbound signals transferred, from a mobile station in the coverage area of the base station 101, to the channel element 240 of the base station 101 via the antenna array 255, the RF transceiver 250 and the transceiver IF 245. Preferably, the antenna array 255 is a multi-sector antenna, for example, a three sector antenna in which each antenna sector is responsible for transmitting and receiving in a 120° arc of coverage area. Additionally, the transceiver 250 may contain an antenna selection unit to select among different antennas in the antenna array 255 during both transmit and receive operations. Alternatively, the antenna array 255 may be an adaptive antenna array or a smart antenna array.

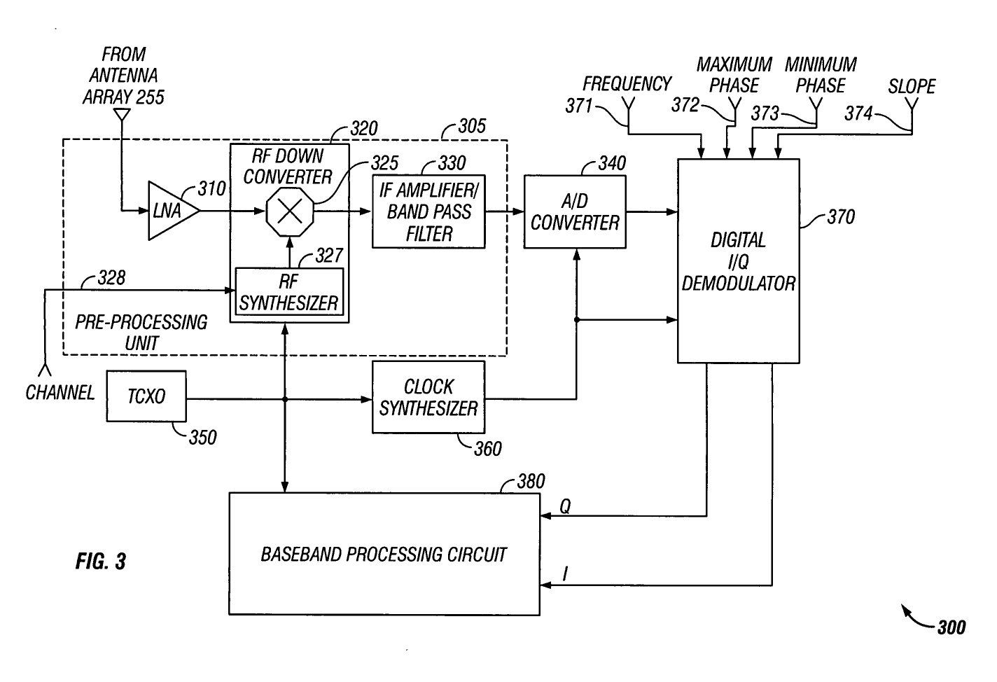

Referring next to FIG. 3, an RF receiver 300 forming part of the RF transceiver 250 of FIG. 2 will now be described in greater detail. As may now be seen, the RF receiver 300 comprises a pre-processing unit 305 (shown in phantom in FIG. 3) having an input coupled to the antenna array 255 and an output, an analog-to-digital (AID) converter 340 having an input coupled to the pre-processing unit 305 and an output, an oscillator, for example, a temperature compensated crystal oscillator (TCXO) 350 or other type of crystal oscillator, a clock synthesizer 360, a digital I/Q demodulator 370 having an input coupled to the output of the A/D converter 340, a first (or “I”) output and a second (or “Q”) output, and a baseband processing circuit 380 having first and second inputs coupled to the I and Q outputs, respectively, of the digital I/Q demodulator 370. In turn, the pre-processing unit 305 comprises a low-noise amplifier (LNA) 310, an RF down converter 320 (which, itself, comprises a mixer 325 and an RF synthesizer 327) and an intermediate frequency (IF) amplifier/band pass filter 330.

The base station 101 is in two-way communication with the mobile station 111 and, as part of the two-way communication therebetween, the mobile station 111 will periodically transmit a modulated analog RF signal. As the mobile station is within the cell site 121, the antenna array 255 of the base station 101 will intercept or otherwise receive the modulated analog RF signal transmitted by the mobile station 111. The antenna array 255 passes the modulated analog RF signal to the pre-processing unit 305 which, as will be more fully described below, processes the modulated analog RF signal in preparation for conversion of the signal into a modulated digital signal and subsequent extraction of a data signal therefrom.

More specifically, within the pre-processing unit 305, the modulated analog RF signal is first passed to the LNA 310. The LNA 310 raises the signal to a level sufficiently high to effectively drive mixer circuitry, more specifically, the mixer 325, located downstream relative to the LNA 310. Once amplified by the LNA 310, the RF signal is passed to a first input of the mixer 325 of the RF down converter 320. The RF down converter 320 is configured to isolate a large range of frequencies of the RF signal input thereto. Within this range, the RF synthesizer 327 will select a particular channel or frequency range, hereinafter referred to as an intermediate frequency (IF), to be passed to the IF amplifier/band pass filter 330. The particular channel to be passed to the IF amplifier/band pass filter 330 is selected, by the RF synthesizer, to be the channel identified by channel input 328. It is contemplated that the channel input 328 may originate at various locations. For example, if the receiver 300 forms part of the base station 101, the signal passed to the RF synthesizer 327 over the channel input 328 would originate at the channel controller 235. The modulated analog IF signal is subsequently passed to the IF amplifier/band pass filter 330 for elimination of unwanted signal and noise. The filtered signal is then output the pre-processing unit 305. Having completed pre-processing, the modulated analog IF signal output the IF amplifier/band pass filter 330 is ready for digitization and subsequent extraction of a digital data signal therefrom. Of course, it should be clearly understood that the processing of the intercepted signal performed by the pre-processing unit 305 described herein is purely exemplary and that the pre-processing unit 305 may be modified to include other processing techniques in addition to or in place of one or more of the processing techniques specifically recited herein.

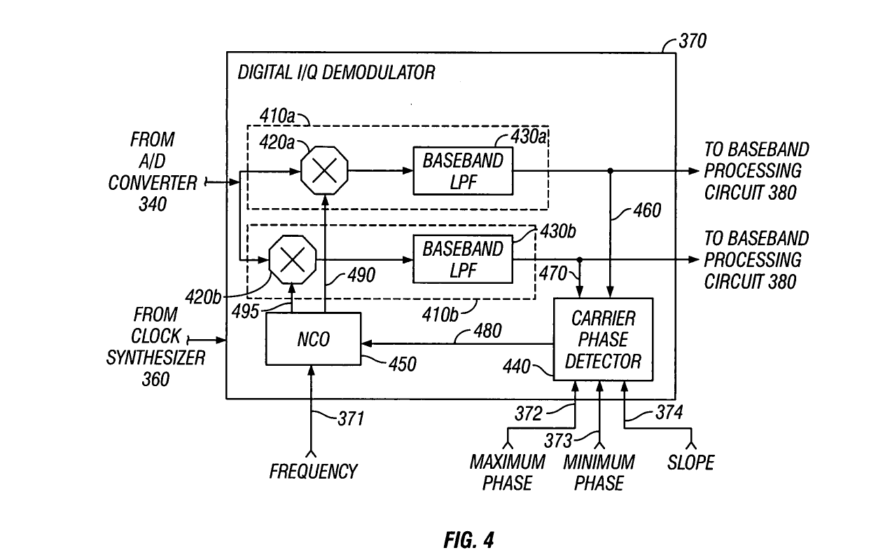

The modulated analog IF signal output the pre-processing unit 305 proceeds to the A/D converter 340. There, the modulated analog IF signal is converted into a modulated digital IF signal. After the digitization thereof, the modulated digital IF signal is passed to the digital I/Q demodulator 370 where, as will be more fully described below with respect to FIG. 4, amplitude and phase information for a digital data signal contained within the modulated digital IF signal input the digital I/Q demodulator 370 is extracted from the modulated digital IF signal and resolved into its I and Q components. The I and Q components of the digital data signal are then passed, by the digital I/Q demodulator 370, to the baseband processing circuit 380 where further processing of the I and Q components of the digital data signal, the particulars of which are beyond the scope of the present invention, is performed. Uniquely, the digital I/Q demodulator 370 includes plural programmable inputs, specifically, programmable inputs 371, 372, 373 and 374, each of which may be used by an operator of the RF receiver 300 to control an operating parameter thereof. More specifically, the programmable input 371 may be used to set the frequency of a local carrier signal generated by the digital I/Q demodulator. The programmable inputs 372 and 373 may be used to set maximum and minimum levels for phase offset determined by the digital I/Q demodulator 370. Together, the maximum and minimum phase offset levels are used, by the digital I/Q demodulator 370 to define a range over which the determined level of phase offset can extend. Finally, the programmable input 374 is a slope control input which may be used to adjust the tracking time for the carrier signal recovery loop which, as will be more fully described below, is contained, in its entirety, within the digital I/Q demodulator 370. By adjusting the tracking time, the frequency of the local carrier signal generated by the digital I/Q demodulator 370 may be even better matched to the frequency of the modulated digital IF signal input the digital I/Q demodulator 370.

Referring next to FIG. 4, the digital I/Q demodulator 370 will now be described in greater detail. As may now be seen, the digital I/Q demodulator 370 comprises a first demodulation sub-circuit 410a (which itself comprises a multiplier 420a and a baseband low pass filter (LPF) 430a) having a first input coupled to the output of the A/D converter 340, a second input and an output, a second demodulation sub-circuit 410b (which, itself, comprises a multiplier 420b and a baseband LPF 430b) having a first input coupled to the output of the A/D converter 340, a second input and an output, a carrier phase detector 440 having a first input coupled to the output of the first demodulation sub-circuit 410a, a second input coupled to the output of the second demodulation sub-circuit 410b and an output and a numerically controlled oscillator (NCO) 450 having an input coupled to the output of the carrier phase detector 440, a first output coupled to the second input of the first demodulation sub-circuit 410a and a second output coupled to the second input of the second demodulation sub-circuit 410b. As may be further seen in FIG. 4, certain ones of the programmable inputs are directed to certain components of the digital I/Q demodulator 370, thereby providing those components of the digital I/Q demodulator 370 with the functionality associated with the corresponding ones of the programmable inputs 371, 372, 373 and 374. More specifically, the programmable input 371 is coupled to the NCO 450 while the programmable inputs 372, 373 and 374 are coupled to the carrier phase detector 440.

The digital I/Q demodulator 370 uses two matched demodulator sub-circuits, specifically, the first and second demodulator sub-circuits 410a and 410b, to remove, from the modulated digital IF signal output the A/D converter 340, the amplitude and phase information, respectively, for a demodulated digital data signal and directly resolve the extracted amplitude and phase information into I and Q components of the demodulated digital data signal. Upon input the digital I/Q demodulator 370, the modulated digital IF signal output the A/D converter 340 is split, for example, using a IF signal splitter (not shown), so that the modulated digital IF signal propagates to both the multiplier 420a of the first demodulation sub-circuit 410a and to the multiplier 420b of the second demodulation sub-circuit 410b. In the embodiment illustrated in FIG. 4, the splitter resides within the digital I/Q demodulator 370. Alternately, however, it is contemplated that the splitter may be positioned between the A/D converter 340 and the digital I/Q demodulator 370 or even reside within the A/D converter 340 itself.

As will be more fully described below, the NCO 450 generates a first sinusoidal carrier signal cosωₒt for input to the first multiplier 420a and a second sinusoidal carrier signal sinωₒt for input to the second multiplier 420b. It is this 90° phase shift between the first and second carrier signals that provides the mechanism by which the I component of the demodulated digital data signal is distinguished from the Q component of the demodulated digital data signal. Accordingly, the multiplier 420a produces the I component of the demodulated digital data signal from the modulated digital IF signal and the first carrier signal cosωₒt. while the multiplier 420b produces the Q component of the demodulated digital data signal from the modulated digital IF signal and the second carrier signal sinωₒt. The output of the multipliers 420a, 420b are subsequently fed to the baseband LPFs 430a, 430b, respectively, for extraction of unwanted images, carriers and noise.

After filtering is complete, the I component of the demodulated digital data signal passes from the baseband LPF 430a to the baseband processing circuit 380. Similarly, after filtering is complete, the Q component of the demodulated digital data signal passes from the baseband LPF 430b to the baseband processing circuit 380. Before being output the digital I/Q demodulator 370, passive monitoring of the outputs of the baseband LPFs 430a and 430b by the carrier phase detector sub-circuit 440 enables the carrier phase detector sub-circuit 440 to acquire information related to the I and Q components of the demodulated digital data signal. More specifically, the carrier phase detector sub-circuit 440 uses passive monitoring to look at the outputs of the baseband LPFs 430a and 430b without interrupting the propagation of the signals output the baseband LPFs 430a and 430b to the baseband processing circuit 380. Phase information detected by the carrier phase detector sub-circuit 440 is then acquired by the carrier phase detector sub-circuit 440, for example, by generating, within the carrier phase detector sub-circuit 440 itself, a replica of the detected phase information. Non-phase related information, on the other hand, is ignored by the carrier phase detector sub-circuit 440. By passively monitoring the outputs of the baseband LPFs 430a and 430b, the carrier phase detector sub-circuit 440 acquires, on lines 460 and 470, the information necessary to correct for phase error without affecting receipt of the I and Q components of the demodulated digital data signal by the baseband processing circuit 380.

From the phase information passively acquired, by the carrier phase detector sub-circuit 440, by monitoring the I and Q components of the demodulated digital data signal, the carrier phase detector sub-circuit 440 determines if there is any difference in phase between the modulated digital data signal from which the I and Q components of the demodulated digital data signal were extracted and the original carrier signal. If a phase difference is detected, the carrier phase detector sub-circuit 440 generates an error signal which represents the difference in phase between the modulated digital data signal from which the I and Q components of the demodulated digital data signal were extracted and the original carrier signal and passes the error signal to the NCO 450.

The NCO 450 of the digital I/Q demodulator 370 must generate first and second carrier signals, each having a frequency matching the frequency of the transmitter oscillator that generated the modulated RF wave intercepted by the receiver 300. If the frequencies of the transmitter oscillator and the NCO 450 are not matched, the digital I/Q demodulator 370 cannot efficiently demodulate the intercepted RF signal. Initially, the NCO 450 generated the first carrier signal cosωₒt. and the second carrier signal sinωₒt at the frequency provided by the programmable input 371. Subsequent to the receipt of the phase error signal, however, the NCO 450 adjusts the first carrier signal cosωₒt. and the second carrier signal sinωₒt to compensate for the level of phase error determined by the carrier phase detector sub-circuit 440. By doing so, the first carrier signal cosωₒt. and the second carrier signal sinωₒt will again match the frequency of the transmitter oscillator.

Generally, a signal recovery loop enables a first device to independently generate a signal which constantly matches or otherwise tracks changes in a signal generated by a second device. For example, a demodulator uses a carrier signal recovery loop to generate a local carrier signal which matches the carrier signal used by a transmitter oscillator to modulate a data signal subsequently transmitted to a receiver which incorporates the demodulator. Uniquely, and in sharp contrast to carrier signal recovery loops used in conjunction with prior demodulators, the digital carrier signal recovery loop comprises a plurality of digital sub-circuits or other digital components completely self-contained within the digital I/Q demodulator 370. In other words, the digital carrier signal recovery loop remains, in its entirety, within the device, here, the digital I/Q demodulator 370, requiring the generated local carrier signal. Thus, in one embodiment, the digital carrier signal recovery loop may comprise those sub-circuits or other components, specifically, the carrier phase detector sub-circuit 440 and the NCO 450, residing within the digital I/Q demodulator 370 needed to generate a local carrier signal suitable for demodulating the signal input the digital I/Q demodulator 370. In another embodiment, the digital carrier signal recovery loop may also comprise those electrical connectors which interconnect the carrier phase detector sub-circuit 440 and the NCO 450 with one another and with other sub-circuits or components of the digital I/Q demodulator 370. Thus, in this embodiment, the digital carrier signal recovery loop may further comprise the lines 460 and 470, along which passively monitored information related to the I and Q components of the demodulated digital data signal pass to the carrier phase detector sub-circuit 440, the line 480, along which the phase offset error propagates from the carrier phase detector sub-circuit 440 to the NCO 450 and the lines 490 and 495, along which the first carrier signal cosωₒt. and the second carrier signal sinωₒt, propagate to the multipliers 420a and 420b, respectively, after correction for phase offset.

The present invention further distinguishes itself over prior demodulators by embedding the demodulation process entirely within digital circuitry, specifically, the digital I/Q demodulator 370 which, as previously set forth, is coupled to receive a modulated digital IF signal as an input thereto and to produce, as first and second outputs therefrom, I and Q components of a demodulated digital data signal. By embedding the demodulation process entirely within digital circuitry, various benefits, most notably, the speed and accuracy at which the digital I/Q demodulator 370 will both construct and periodically adjust a carrier signal for demodulating subsequently received modulated digital IF signals. This is particularly true in that the carrier recovery loop used to construct and periodically adjust the carrier signal resides entirely within the digital I/Q demodulator 370 and is, therefore, entirely constructed of digital components as well.

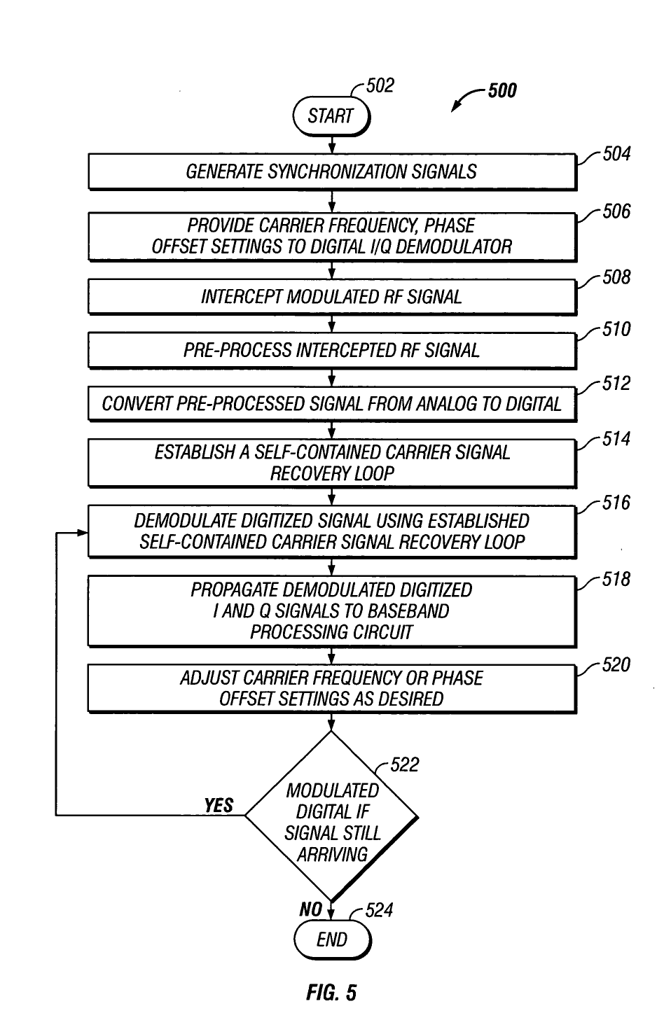

Referring next to FIG. 5, a method 500 of processing data, for example, by demodulating a modulated analog RF signal, will now be described in greater detail. The method 500 commences at step 502 and, at step 504, synchronization signals are generated for the device, for example, the RF receiver 300 or the digital I/Q demodulator 370, to demodulate a modulated analog RF signal. In the embodiment of the invention disclosed herein, the TCXO 350 generates a synchronization signal having a frequency set to the frequency of the carrier signal. From the TCXO 350, the synchronization signal is propagated to the RF synthesizer 327, the clock synthesizer 360 and the baseband processing circuit 380. Using the synchronization signal received from the TXCO 350, the RF synthesizer 327 generates an RF signal, having a frequency matching the frequency of the carrier signal, for selecting, from the intercepted RF signal, a channel frequency, selected using the input 328, for further processing. In turn, the RF signal generated by the RF synthesizer 327 propagates to the mixer 325 where it is combined with the intercepted RF signal such that output of the mixer 325 is that portion of the intercepted RF signal corresponding to the selected channel frequency.

Also during step 504, and again using the synchronization signal received from the TXCO 350, the clock synthesizer 360 generates a clock signal, having a frequency set to the frequency of the carrier signal. Once generated thereby, the clock synthesizer 360 propagates the clock signal to the A/D converter 340 for use in timing the A/D conversion of the IF signal output the IF amplifier/band pass filter 330 and to the digital I/Q demodulator 370 for use in demodulating the digitized IF signal output the A/D converter 340. While not specifically shown in FIG. 4, the clock signal output the clock synthesizer 360 is tied to each of the sub-circuits and other components or other devices, for example, the multipliers 420a and 420b, the baseband LPFs 430a and 430b, the carrier phase detector sub-circuit 440 and the NCO 450, collectively forming the digital I/Q demodulator 370 to ensure that data and carrier signals are properly clocked through the device. The digital I/Q demodulator 370 also uses the clock signal to establish a frequency range for the local carrier signal generated thereby. Preferably, the frequency range established by the digital I/Q demodulator 370 from the clock signal extends from 0 to ½ of a clock pulse. Finally, the baseband processing circuit 380 also uses the synchronization signals generated by the TCXO 350 to perform additional processing of the digitized I and Q components of the data signal which is beyond the scope of the present invention and need not, therefore, be described in detail. Continuing on to step 506, user selectable parameters, for example, carrier frequency and phase offset settings, are input the digital I/Q demodulator 370 using one or more programmable inputs, for example, the first, second, third and fourth programmable inputs 371, 372, 373 and 374. Typically, the frequency of the carrier signal and the phase offset range are input the digital I/Q demodulator 370 at step 506 by operator manipulation of the programmable inputs 371, 372, 373 and 374.

Steps 504 and 506 may be generally characterized as preparatory steps often needed to prepare the digital I/Q demodulator 370 for a demodulation process. Having completed the preparatory steps, the digital I/Q demodulator 370 is ready to enter a data processing stage. In the embodiment disclosed herein, the data processing stage commences at step 508 with interception, by the RF receiver 300, of the data signal to be processed, here, a modulated analog RF signal. Of course, it is fully contemplated that the data processing method disclosed herein is equally suitable for use in processing data propagated to, rather than intercepted by, the RF receiver 300. It is further contemplated that the present invention may be used in conjunction with other types of data processing techniques and/or devices which may benefit from the incorporation of a self contained signal recovery loop therein.

Upon interception of the modulated analog RF signal at step 508, the method proceeds to step 510 where the intercepted modulated analog RF signal undergoes pre-processing, typically, using the pre-processing unit 305. For example, the intercepted modulated analog RF signal may, as part of the pre-processing sequence, be amplified by the LNA 310, converted to an IF signal by selection of a specified frequency channel by the RF down converter 320 and filtered by IF amplifier/bandpass filter 330. Of course, depending on the characteristics of the particular signal intercepted or otherwise received by the RF receiver 300, the pre-processing sequence may be varied by either: (1) deleting one or more of the disclosed pre-processing steps; (2) modifying one or more of the disclosed pre-processing steps; and/or (3) adding one or more of pre-processing steps to those disclosed herein. After completing the pre-processing stage of the intercepted RF signal by performing the actions listed at step 510, the method proceeds to step 512 for initiation of the data processing stage, which, in the embodiment of the invention disclosed herein, comprises the various steps which must be executed to convert the modulated analog IF signal produced by pre-processing step 510 into I and Q components of a demodulated digital data signal.

Processing of the pre-processed modulated analog IF signal commences at step 512 with the conversion, by the A/D converter 340, of the modulated analog IF signal into a modulated digital IF signal. At step 514, the method continues with the establishment of a self-contained digital carrier signal recovery loop. To establish a digital carrier signal recovery loop and contain it within the digital I/Q demodulator 370, the modulated digital IF signal passed to the digital I/Q demodulator 370 is split into first and second generally identical signals, the first of which is passed to the multiplier 420a of the first demodulation sub-circuit 410a and the second of which is passed to the multiplier 420b of the second demodulation sub-circuit 410b. Splitting of the digitized RF signal may be performed by any number of suitable devices and/or sub-circuits, for example, using a signal splitter sub-circuit (not shown) forming part of the digital I/Q demodulator 370. Of course, rather than incorporating the signal splitter or other device and/or sub-circuit into the digital I/Q demodulator 370 as shown in FIG. 4, in an alternate embodiment of the invention, the modulated digital IF signal may be split into first and second generally identical signals before being input the digital I/Q demodulator 370.

As previously set forth, within the multiplier 420a, the modulated digital IF signal is combined with an initial determination of the first carrier signal. Similarly, within the multiplier 420b, the modulated digital IF signal is combined with an initial determination of the second carrier signal. Initially, the first carrier signal is comprised of sinusoidal wave cosw₀t and is generated by the NCO 450 at the frequency input the digital I/Q demodulator 370 by the operator. The second carrier signal, on the other hand, is initially comprised of the first carrier signal shifted by 90 degrees. In other words, the second carrier signal is comprised of sinusoidal wave sinω₀t, which, like the first carrier signal cosω₀t, is generated by the NCO 450 at the frequency input the digital I/Q demodulator 370 by the user. By combining the modulated digital IF signal with the first carrier signal cosωₒt, the I component of the demodulated digital data signal contained in the modulated digital IF signal is extracted from the carrier wave within which the data was modulated. Similarly, by combining the modulated digital IF signal with the second carrier signal sin ω₀t, the Q component of the demodulated digital data signal contained in the modulated digital IF signal is extracted from the carrier wave within which the data was modulated. The I and Q components of the demodulated digital data signals are passed to the baseband LPFs 430a and 430b, respectively, thereby eliminating extraneous signals, for example, unwanted images, carriers and noise, therefrom.

The carrier phase detector sub-circuit 440 passively monitors the I and Q components of the demodulated digital data signals output the baseband LPFs 430a and 430b to acquire phase information from the I and Q components of the demodulated digital data signals without affecting the transmission of the I and Q components of the demodulated data signals to the baseband processing circuit 380. Within the carrier phase detector sub-circuit 440, the level of phase offset, which is the same for both the first and second carrier signals, for the digital I/Q demodulator 370 is determined from the phase information acquired from the I and Q components of the demodulated data signal. After being determined by the carrier phase detector sub-circuit 440, the level of the phase offset is passed, by the carrier phase detector sub-circuit 440, to the NCO 450 for use thereby. It is noted that the level of phase offset must be determined to be within the range defined by the minimum and maximum phase levels input the carrier phase detector sub-circuit 440 by the operator using the programmable inputs 372 and 373. If not, the carrier phase detector sub-circuit 440 should generate an error message to the operator advising of the out-of-range level of phase offset determined thereby. The operator may then take appropriate action in response thereto.

Using the phase offset signal received from the carrier phase detector sub-circuit 440, the NCO 450 generates adjusted first and second carrier signals. Generally, the adjusted first and second carrier signals generated by the NCO 450 respectively comprise the first and second carrier signals cosω₀t and sinω₀t, again, at the frequency f input by the operator using the programmable 440. After determination thereof, the NCO 450 propagates the compensated first and second carrier signals to the multipliers 420a and 420b, respectively, for use in place of the initial first and second carrier signals.

The aforedescribed process represents a single iteration of the digital carrier signal recovery loop. Subsequent reiterations of the digital carrier signal recovery loop are performed in a similar manner. In other words, the multipliers 420a and 420b will continue to combine the modulated digital IF signal clocked thereinto with the adjusted first and second carrier signals 430a and 430b, respectively, to produce additional portions of respective streams of the I and Q components of the demodulated digital data signal. The carrier phase detector sub-circuit 440 uses new values for the I and Q components to determine a new level for the phase offset. In turn, the newly determined level for the phase offset is used by the NCO 450 to determine new adjusted first and second carrier signals to be propagated to the first and second multipliers 420a and 420b, thereby completing another iteration of the carrier signal recovery loop.

Having established a self-contained digital carrier signal recovery loop at step 514, the method proceeds to step 516 where the modulated digital IF signal clocked into the multipliers 420a and 420b are again demodulated and resolved into the I and Q components of the demodulated digital signal, again by combining the modulated digital IF signal with the adjusted first and second carrier signals, respectively, generated by the NCO 450. The method then continues on to step 518 where the I and Q components of the demodulated digital data signal are propagated to the baseband processing circuit 380 for further processing thereof. Of course, it should be noted that, as the I and Q components of the demodulated digital data signal are propagated to the baseband processing circuit 380 generally simultaneous with the passive acquisition, by the carrier phase detector sub-circuit 440, of phase information from the I and Q components of the demodulated digital data signal, so long as modulated digital IF data continues to be clocked into the digital I/Q demodulator 370, the steps 514, 516 and 518 tend to execute in a generally continuous manner.

Proceeding on to step 520, the operator of the receiver 300 may, if desired, opt to adjust the carrier frequency or phase offset settings for the digital I/Q demodulator, for example, by manipulating one or more of the programmable inputs 371, 372, 373 or 374. Of course, the step 520 is somewhat similar in nature to the steps 514, 516 and 518 in that the operator may decide to execute the step 520 at any time. Generally, the first programmable input 371 is manipulated whenever the operator intends to adjust the frequency of the first and second carrier signals generated by the NCO 450. The second and third programmable inputs 372 and 373 are manipulated whenever the operator intends to adjust the high bound or low bound, respectively, of the permitted range of phase offset. Finally, the fourth programmable input 374 is manipulated whenever the operator intends to adjust the phase of the first and second carrier signals to further correct tracking errors between the transmitter carrier signal and the first and second carrier signals generated by the NCO 450. Generally, the fourth programmable input 374 corrects tracking error by manually adjusting the level of detected phase offset indicated in the phase offset signal to be propagated to the NCO 450.

After all desired operator adjustments are completed at step 520, the method proceeds to step 522 for further processing. If it is determined, at step 522, that a modulated digital IF signal continues to be clocked into the digital I/Q demodulator 370, the method will return to step 516 for further processing of the received modulated digital IF signal in the manner previously set forth. Of course, as part of this process, the first and second carrier signals will be adjusted each time that the phase information acquired from the I and Q components of the digital data signal indicates a phase change. If, however, the modulated digital IF signal is no longer being clocked into the digital I/Q demodulator 370, the method ends at step 524.

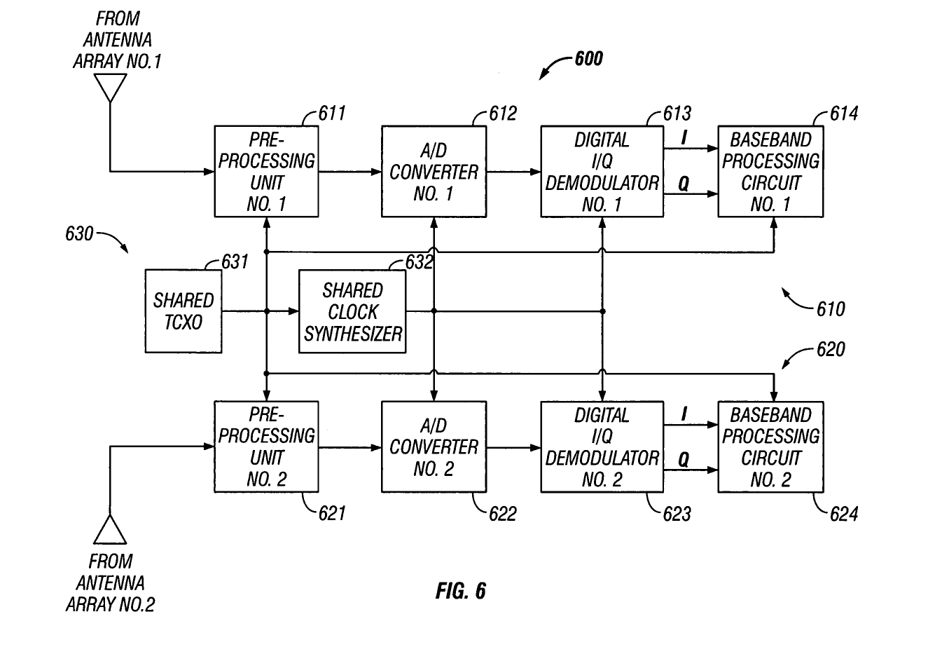

Referring next to FIG. 6, an alternate embodiment of an RF receiver, here, RF receiver 600, also constructed in accordance with the teachings of the present invention will now be described in greater detail. As may now be seen, the RF receiver 600 differs from the RF receiver 300 described with respect to FIG. 3 in that the RF receiver 600 incorporates plural digital I/Q demodulators. In the embodiment of the invention disclosed herein, the RF receiver 600 includes a first digital I/Q demodulator 613 and a second digital I/Q demodulator 623. It should be clearly understood, however, that it is fully contemplated that the RF receiver 600 may include any number of digital I/Q demodulators. By including multiple digital I/Q demodulators therein, the RF receiver 600 is capable of intercepting multiple signals, each characterized by a respective carrier signal. As a result, the capabilities of the RF receiver 600 are substantially enhanced.

As may now be seen, the RF receiver 600 is comprised of a first signal processing section 610, a second signal processing section 620 generally identical to the first signal processing section 610, and a shared section 630. As will be more fully described below, the first signal processing section 610 handles a first signal comprised of a first data signal modulated using a first carrier signal, the second signal processing section 620 handles a second signal comprised of a second data signal modulated by a second carrier signal and the shared section provides certain, generally identical, types of timing information to both the first signal processing section 610 and the second signal processing section 620.

As may now be seen, the first signal processing section 610 comprises a first pre-processing unit 611 having an input coupled to antenna array no. 1 (not shown) and an output, a first A/D converter 612 having an input coupled to the output of the first pre-processing unit 611 and an output, a first digital I/Q demodulator 613 having an input coupled to the output of the first A/D converter 612, an I output and a Q output, and a first baseband processing circuit 614 having first and second inputs coupled to the I and Q outputs, respectively, of the first digital I/Q demodulator 613. The first pre-processing unit 611, the first A/D converter 612, the first digital I/Q demodulator 613 and the first baseband processing circuit 614 are generally identical to the pre-processing unit 305, the A/D converter 340, the digital I/Q modulator 370 and the baseband processing circuit 380, respectively. Accordingly, further description of the aforementioned components is not necessary. It is further noted that the various components of the first signal processing section 610 are interconnected with one another in a manner generally identical to the interconnection of the corresponding components of the RF receiver 300. Accordingly, further description of the interconnection of these components is also not necessary.

The second signal processing section 620 comprises a second pre-processing unit 621 having an input coupled to antenna array no. 2 (not shown) and an output, a second A/D converter 622 having an input coupled to the output of the second pre-processing unit 621 and an output, a second digital I/Q demodulator 623 having an input coupled to the output of the second A/D converter 622, an I output and a Q output, and a second baseband processing circuit 624 having first and second inputs coupled to the I and Q outputs, respectively, of the second digital I/Q demodulator 623. The second pre-processing unit 621, the second A/D converter 622, the second digital I/Q demodulator 623 and the second baseband processing circuit 624 are generally identical to the pre-processing unit 305, the A/D converter 340, the digital I/Q modulator 370 and the baseband processing circuit 380, respectively. Accordingly, further description of the aforementioned components is not necessary. It is further noted that the various components of the second signal processing section 620 are interconnected with one another in a manner generally identical to the interconnection of the corresponding components of the RF receiver 300. Accordingly, further description of the interconnection of these components is also not necessary.

It should be further appreciated that, apart from their respective connection to antenna arrays nos. 1 and 2, the first and second signal processing sections 610 and 620 are generally identical to one another. As previously set forth, the RF receiver 600 further includes a shared section 630 comprised of a shared TCXO 631 having an output and a shared clock synthesizer 632 having an input and an output. The shared section 630 is generally identically coupled to the first signal processing section 610 and the second signal processing section 620. More specifically, in addition to being coupled to the input of the shared clock synthesizer 360, the output of the shared TCXO 350 is coupled to the first pre-processing unit 611 and the first baseband processing unit 614 of the first signal processing section 610 and to the second pre-processing unit 621 and the second baseband processing unit 624 of the second signal processing section 620. Also, the output of the shared clock synthesizer 632 is coupled to the first A/D converter 612 and the digital I/Q demodulator 613 of the first signal processing section 610 and to the second A/D converter 622 and the second digital I/Q demodulator 623 of the second signal processing section 620.

The components forming the shared section 630 of the RF receiver 600 are generally identical to the corresponding components of the RF receiver 300. In other words, the shared TCXO 631 is generally identical to the TCXO 350 and the shared clock synthesizer 632 is generally identical to the clock synthesizer 360. The shared TCXO 631 and the shared clock synthesizer 632 also provide the same functionality to the RF receiver 600 as the TCXO 350 and the clock synthesizer 360 provide to the RF receiver 300 except that the shared section 630 provide that same functionality to both the first signal processing section 610 and the second signal processing section 620. Accordingly, further details as to the operation of the shared TCXO 631 and the shared clock synthesizer 632 are not deemed necessary.

The RF receiver 600 is configured to intercept first and second RF signals and to demodulate each of the acquired intercepted signals. As separate signal processing sections 610 and 620 are provided, the first and second RF signals may be different type signals. In one example, the first and second RF signals may be of the same type of signal but modulated using discrete carrier signals. In another example, the first and second RF signals may be of discrete signal types. By equipping an RF receiver with the capability of handling multiple types of RF signals, the functionality of the RF receiver is greatly extended. Further, by sharing selected components between those portions of the RF receiver designated to demodulate different types of RF signals, the increase in functionality is not matched by a corresponding increase in manufacturing costs.

Thus, there has been described and illustrated herein, a digital I/Q demodulator suitable for use in wireless networks and an associated method of demodulating an RF signal. By embedding the demodulation process entirely within digital components, the resultant digital I/Q demodulator enjoys faster response times and greater accuracy than prior demodulators configured to demodulate analog RF signals. Further, by constructing the digital I/Q demodulator to include an entirely self-contained, as well as substantially simplified, digital carrier signal recovery loop comprised only of digital components, the digital I/Q demodulator disclosed herein enjoys superior carrier signal recovery characteristics when compared to prior demodulators. Still further, by separating the oscillator components which synchronize the digital I/Q demodulator from those which generate the adjusted carrier signal, less expensive oscillators, for example, TCXOs or crystal oscillators may be used in the disclosed digital I/Q demodulator in place of the much more expensive voltage controlled temperature compensated crystal oscillators (VCTCXOs) commonly used in prior demodulators. Still yet further, by providing the digital I/Q demodulator with plural programmable inputs not found in prior demodulators, the disclosed digital I/Q demodulator is suitable for use in a wide variety of environments and/or devices. Finally, by providing the digital I/Q demodulator with the capability of demodulating multiple types of RF signals while sharing certain components thereof between a first signal processing section configured to demodulate a first type of RF signal and a second signal processing section configured to demodulate a second type of RF signal, the digital I/Q demodulator enjoys extended functionality without a corresponding increase in manufacturing costs.

Those skilled in the art should recognize that the embodiments of the invention disclosed herein are purely illustrative and that numerous modifications and variations thereof may be made while remaining within the spirit and scope of the present invention. Accordingly, the scope of protection sought herein is as set forth in the claims below.

What is claimed is:

1. A digital in-phase/quadrature (I/Q) demodulator, comprising:
a first demodulation sub-circuit having an input and an output, said first demodulation circuit converting a modulated digital signal received at said input into an I component of a digital demodulated signal, said I component to be applied to said output;
a second demodulation sub-circuit having an input and an output, said second demodulation circuit converting said modulated digital signal received at said input into a Q component of a digital demodulated signal, said Q component to be applied to said output;
a carrier signal phase offset detection sub-circuit coupled for passive monitoring of said output of said first demodulation sub-circuit and output of said second demodulation sub-circuit, said carrier signal phase offset detection sub-circuit using phase information acquired during passive monitoring of said output of said first demodulation sub-circuit and said output of said second demodulation sub-circuit to determine a phase offset to be applied to an output thereof;
a carrier signal generation sub-circuit, said carrier generation sub-circuit having an input coupled to said output of said carrier signal phase offset detection sub-circuit, a first output coupled to said first demodulation sub-circuit and a second output coupled to said second demodulation sub-circuit, said carrier signal generation sub-circuit constructing first and second carrier signals to be used by said first demodulation sub-circuit and said second demodulation sub-circuit, respectively, to demodulate said modulated digital signal;
said outputs of said first and second demodulation sub-circuits, said carrier signal phase offset detection sub-circuit, said carrier signal generation sub-circuit and said output of said carrier signal generation sub-circuit defining a completely self contained digital carrier recovery loop within said digital I/Q demodulator.

2. The demodulator of claim 1, wherein said carrier signal generation sub-circuit further comprises a programmable input for providing said carrier signal generation sub-circuit with a selected frequency for said carrier signal.

3. The demodulator of claim 2, wherein said carrier signal generation sub-circuit further comprises a clock input for providing said carrier signal generation sub-circuit with a frequency range for said first and second carrier signals.

4. The demodulator of claim 3, wherein:
said carrier signal generation sub-circuit further comprises a numerically controlled oscillator (NCO);
said NCO is configured to provide said first demodulation sub-circuit with said first carrier signal, said first carrier signal comprised of a cosine wave, phase corrected for said phase offset determined by said carrier signal phase offset detector sub-circuit, having a frequency within said frequency range, said frequency selected using said programmable input; and wherein
said NCO is further configured to provide said second demodulation sub-circuit with said second carrier signal, said second carrier signal comprised of a sine wave, phase corrected for said phase offset determined by said carrier signal phase offset detector sub-circuit, having a frequency within said frequency range, said frequency selected using said programmable input.

5. The demodulator of claim 3, wherein said carrier signal phase offset detector sub-circuit further comprises a first programmable input for adjusting said phase offset determined by said carrier signal phase offset detector sub-circuit.

6. The demodulator of claim 5, wherein said carrier signal phase offset detector sub-circuit further comprises second and third programmable inputs for setting a range for said phase offset.

7. A radio frequency (RF) receiver, comprising:
an analog-to-digital (A/D) converter having an input and an output, said A/D converter converting a modulated analog RF signal received at said input to a modulated digital RF signal; and
a digital in-phase/quadrature (I/Q) demodulator having an input, a first output and a second output, said input of said digital I/Q demodulator coupled to said output of said A/D converter, said digital I/Q demodulator receiving said modulated digital RF signal from said A/D converter and producing I and Q components of a demodulated digital RF signal from said modulated digital RF signal;
said digital I/Q demodulator further comprising a self-contained digital carrier signal recovery loop for generating a phase offset corrected carrier signal for use in producing said I and Q components of said demodulated digital RF signal from said modulated digital RF signal.

8. The RF receiver of claim 7, wherein said digital I/Q demodulator further comprises a first programmable input for providing said digital I/Q demodulator with a selected frequency for said phase offset corrected carrier signal.

9. The RF receiver of claim 8, and further comprising:
a clock circuit having an output coupled to a clock input for said A/D converter and to a clock input for said digital I/Q demodulator;
said digital I/Q demodulator using a clocking signal received at said clock input to determine a frequency range for said phase offset corrected carrier signal.

10. The RF receiver of claim 9, wherein said digital I/Q demodulator further comprises a second and third programmable input for respectively setting maximum and minimum values of a phase offset range for said phase offset corrected carrier signal.

11. The RF receiver of claim 10, wherein said digital I/Q demodulator further comprises a fourth programmable input for adjusting phase offset for said phase offset corrected carrier signal.

12. The RF receiver of claim 10, wherein said digital I/Q demodulator further comprises a fourth, slope control, programmable input for adjusting tracking time for said phase offset corrected carrier signal.

13. A method of demodulating a modulated analog radio frequency (RF) signal, comprising:
converting a received modulated analog RF signal into a modulated digital RF signal;
providing said modulated digital RF signal to a digital in-phase/quadrature (I/Q) demodulator;
said digital I/Q demodulator demodulating and resolving said modulated digital RF signal to produce I and Q components of a demodulated digital data signal, said I and Q components produced by combining said modulated digital RF signal and a carrier signal, said carrier signal having a frequency which matches the frequency of said modulated analog RF signal;
said digital I/Q demodulator determining a phase offset from said produced I and Q components; and
said digital I/Q demodulator constructing said carrier signal using said determined phase offset.

14. The method of claim 13, wherein constructing said carrier signal using said determined phase offset further comprises:
said digital I/Q demodulator constructing said carrier signal using said determined phase offset and a selectable frequency input said digital I/Q demodulator.

15. The method of claim 14, and further comprising:
said digital I/Q demodulator setting a frequency range within which said selectable frequency must fall.

16. The method of claim 15, and further comprising:
said digital I/Q demodulator setting said frequency range using a clock signal input said digital I/Q demodulator.

17. The method of claim 14, and further comprising:
said digital I/Q demodulator adjusting said determined phase offset using a selectable phase offset adjustment input said digital I/Q demodulator.

18. The method of claim 17, and further comprising:
said digital I/Q demodulator setting a phase offset range within which said determined phase offset must fall.

19. The method of claim 18, and further comprising:
said digital I/Q demodulator setting said phase offset range using a selectable phase offset range input said digital I/Q demodulator.

20. The method of claim 14, wherein demodulating and resolving said modulated digital RF signal to produce said I and Q components of said demodulated digital data signal further comprises:
said digital I/Q demodulator generating, from said modulated digital RF signal, first and second copies of said modulated digital RF signal;
said digital I/Q demodulator constructing a first carrier signal using said determined phase offset and a selected frequency input said digital I/Q demodulator;
said digital I/Q demodulator constructing a second carrier signal using said determined phase offset and said selected frequency;
combining said modulated digital RF signal and said first carrier signal to produce said I component of said demodulated digital data signal; and
combining said modulated digital RF signal and said second carrier signal to produce said Q component of said demodulated digital data signal.

21. A radio frequency (RF) receiver, comprising:
a first signal processing section for handling RF signals of a first RF signal type, said first signal processing section comprised of a first analog-to-digital (A/D) converter having an input and an output, said first A/D converter converting a first modulated analog RF signal of said first RF signal type received at said input to a first modulated digital RF signal, and a first digital in-phase/quadrature (I/Q) demodulator having an input, a first output and a second output, said input of said first digital I/Q demodulator coupled to said output of said first A/D converter, said first digital I/Q demodulator receiving said first modulated digital RF signal from said first A/D converter and producing I and Q components of a first demodulated digital RF signal from said first modulated digital RF signal;
a second signal processing section for handling RF signals of a second RF signal type, said second signal processing section comprised of a second A/D converter having an input and an output, said second A/D converter converting a second modulated analog RF signal of said second RF signal type received at said input to a second modulated digital RF signal, and a second I/Q demodulator having an input, a first output and a second output, said input of said second digital I/Q demodulator coupled to said output of said second A/D converter, said second digital I/Q demodulator receiving said second modulated digital RF signal from said second A/D converter and producing I and Q components of a second demodulated digital RF signal from said second modulated digital RF signal; and
a shared clock circuit having an output coupled to clock inputs for said first A/D converter, said first digital I/Q demodulator, said second A/D converter and said second digital I/Q demodulator.

22. The RF receiver of claim 21, wherein:
said first signal processing section further comprises a first pre-processing unit having an input and an output, said input coupled to receive said first analog modulated RF signal of said first type from a first antenna array and said output coupled to said first A/D converter; and
said second signal processing section further comprises a second pre-processing unit having an input and an output, said input coupled to receive said second analog modulated RF signal of said second type from a second antenna array and said output coupled to said second A/D converter.

23. The RF receiver of claim 22, wherein:
said first signal processing section further comprises a first baseband processing circuit having first and second inputs, said first input coupled to receive said I component of said first digital demodulated signal from said first digital I/Q demodulator and said second input coupled to receive said Q component of said first demodulated digital RF signal from said first digital I/Q demodulator; and
said second signal processing section further comprises a second baseband processing circuit having first and second inputs, said first input coupled to receive said I component of said second digital demodulated signal from said second digital I/Q demodulator and said second input coupled to receive said Q component of said second demodulated digital RF signal from said second digital I/Q demodulator.

24. The RF receiver of claim 23, and further comprising a temperature compensated crystal oscillator (TCXO) having an output coupled to said first pre-processing unit, said first baseband processing circuit, said second pre-processing unit, said second baseband processing circuit and said shared clock circuit.

25. The RF receiver of claim 24, wherein:
said first digital I/Q demodulator further comprises a first self-contained carrier signal recovery loop for generating a first phase offset corrected carrier signal for use in producing said I and Q components of said first demodulated digital RF signal from said first modulated digital RF signal; and
said second digital I/Q demodulator further comprises a second self-contained carrier signal recovery loop for generating a second phase offset corrected carrier signal for use in producing said I and Q components of said second demodulated digital RF signal from said second modulated digital RF signal.

26. The RF receiver of claim 25, wherein:
said first digital I/Q demodulator using a clocking signal received at said clock input thereof to determine a first frequency range for said first phase offset corrected carrier signal; and
said second digital I/Q demodulator using said clocking signal received at said clock input thereof to determine a second frequency range for said second phase offset corrected carrier signal.
